(19) United States
(12) Patent Application Publication
(10) Pub. No.: US 2002/0166406 A1
(43) Pub. Date: Nov. 14, 2002

(54) Bicycle stem

(76) Inventor: Chuck Dunlap, Lakewood, CO (US)

Correspondence Address: DELLETT AND WALTERS, 310 S.W. FOURTH AVENUE, SUITE 1101, PORTLAND, OR, 97204, US

(21) Appl. No.: 10/116,698

(22) Filed: Apr. 3, 2002

Related U.S. Application Data
(60) Provisional application No. 60/282,310, filed on Apr. 5, 2001.

(51) Int. Cl. B62K 21/12

(52) U.S. Cl. 74/551.1

(57) ABSTRACT

A bicycle stem includes a wedge member and corresponding indentation defined in a lower portion of a hollow stem tube, carried on a stem body. The stem body includes a blot that engages the wedge via a through bore from the upper portion of the stem body into the indentation, whereby the wedge may be pulled tighter into the indentation. The wedge has a fork tube engaging surface profile on a face opposite the face engaging the indentation.

### BACKGROUND OF THE INVENTION

This invention relates to bicycles, and more particularly to a bicycle stem.

In bicycle construction, some manner of engagement between the bicycle handle and the front wheel forks must be employed in order to enable the rider to steer the bicycle.

### SUMMARY OF THE INVENTION

In accordance with the invention, a bicycle stem employs a vertically aligned bore in the stem which is adapted to engage with a bicycle fork tube. Within the bore is an indentation, adapted to receive a correspondingly shaped wedge therein. The wedge is threadably engaged by a bolt member, the bolt passing through the stem. On tightening or loosening of the bolt, the wedge is pulled into or out of the indentation. The wedge includes a fork tube engaging portion to tightly engage the fork tube to secure the stem and fork tube, when the bolt is tightened.

Accordingly, it is an object of the present invention to provide an improved bike stem.

It is a further object of the present invention to provide an improved bike stem employing a substantially vertically moving wedge member.

It is yet another object of the present invention to provide an improved bike stem clamp mechanism for attaching the handle bars of a bike to a steerer tube.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is an exploded perspective view of the bicycle stem according to the present invention;

FIG. 2 is a top exploded view of the bicycle stem;

FIG. 3 is a side exploded view of the bicycle stem;

FIG. 4 is an end exploded view of the bicycle stem taken in the direction of arrow 4 of FIG. 1;

FIG. 5 is a bottom exploded view of the bicycle stem;

FIG. 6 is a solid top exploded partial perspective view of the bicycle stem;

FIG. 7 is a solid top exploded complete perspective view of the bicycle stem;

FIG. 8 is a solid bottom exploded complete perspective view of the bicycle stem;

FIG. 9 is another solid top exploded part perspective view of the bicycle stem taken from a different angle from the view of FIG. 7; and

FIG. 10 is another solid top exploded part perspective view of the bicycle stem taken from a different angle from the view of FIG. 8.

### DETAILED DESCRIPTION

The system according to a preferred embodiment of the present invention comprises a wedge member and corresponding indentation defined in a hollow stem. The stem body includes a bolt that engages the wedge, whereby the wedge may be pulled tighter into the indentation. The wedge has a tube engaging surface on a face opposite the face engaging the indentation, whereby a secure engagement between the tube and the stem is provided by tightening the bolt.

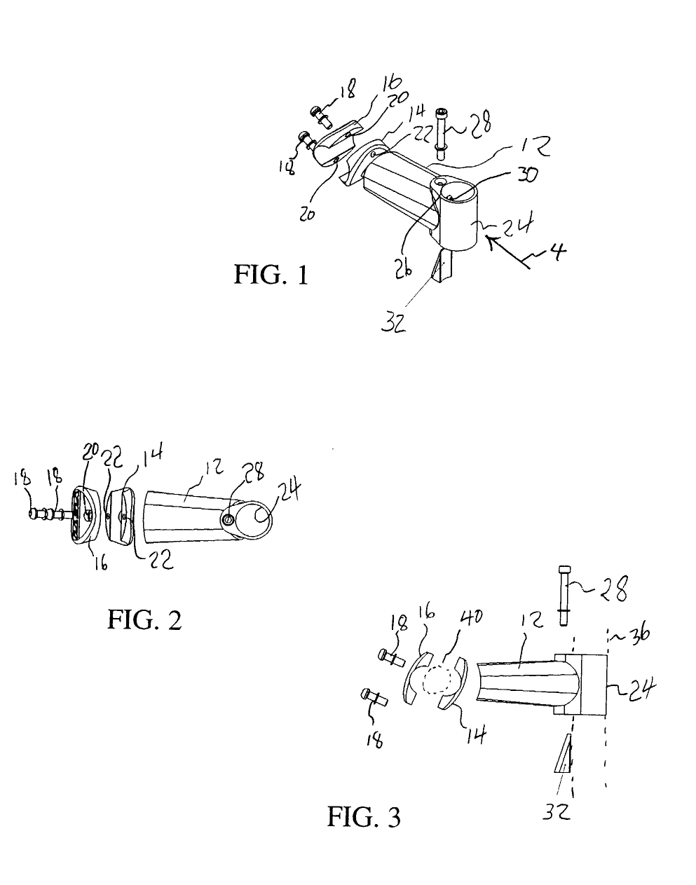

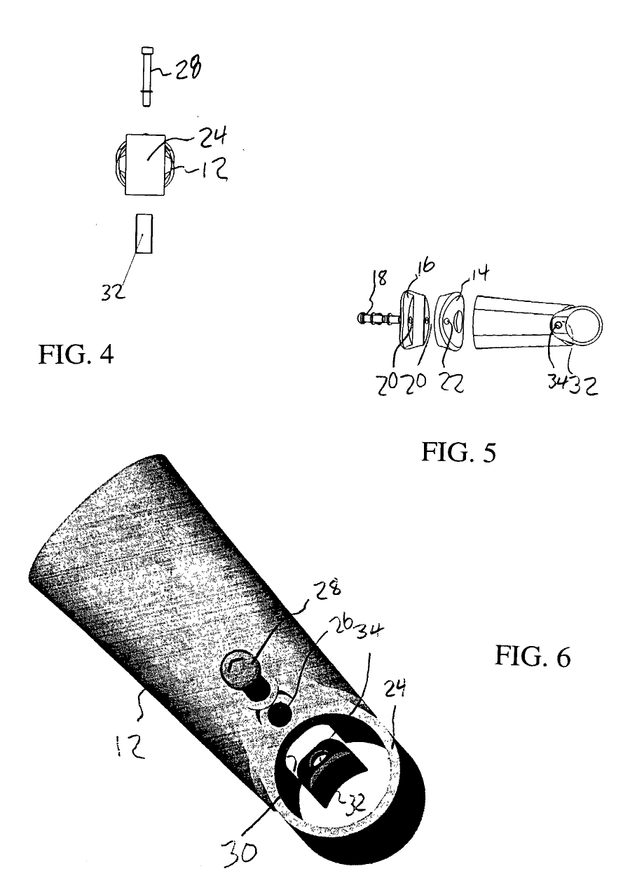

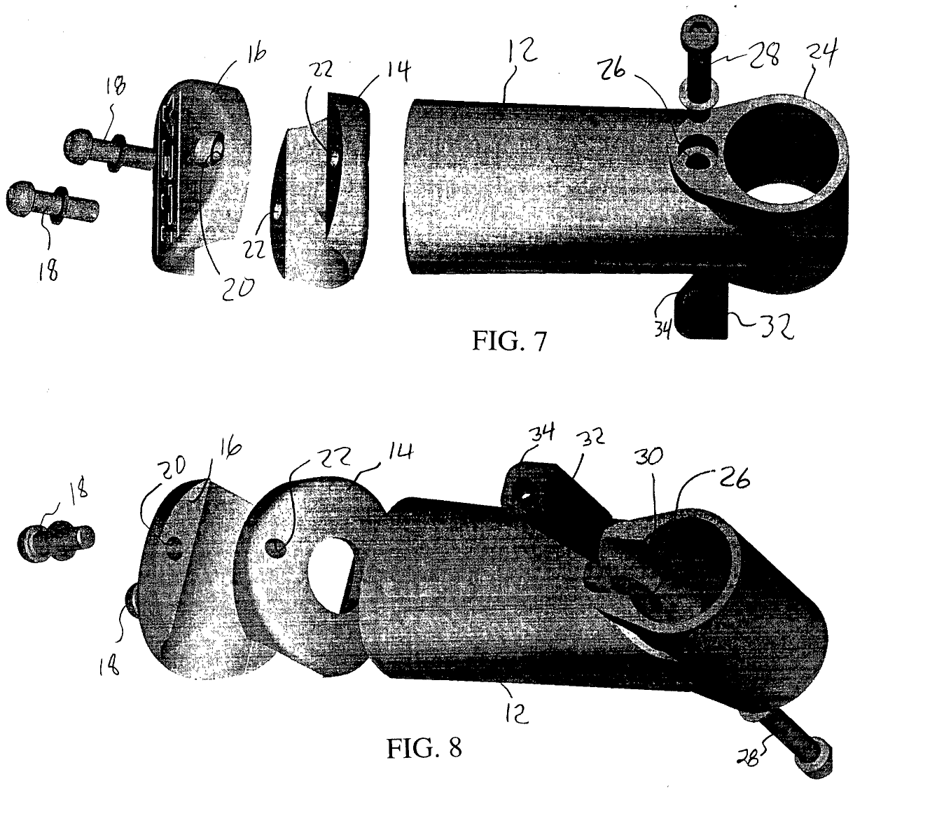

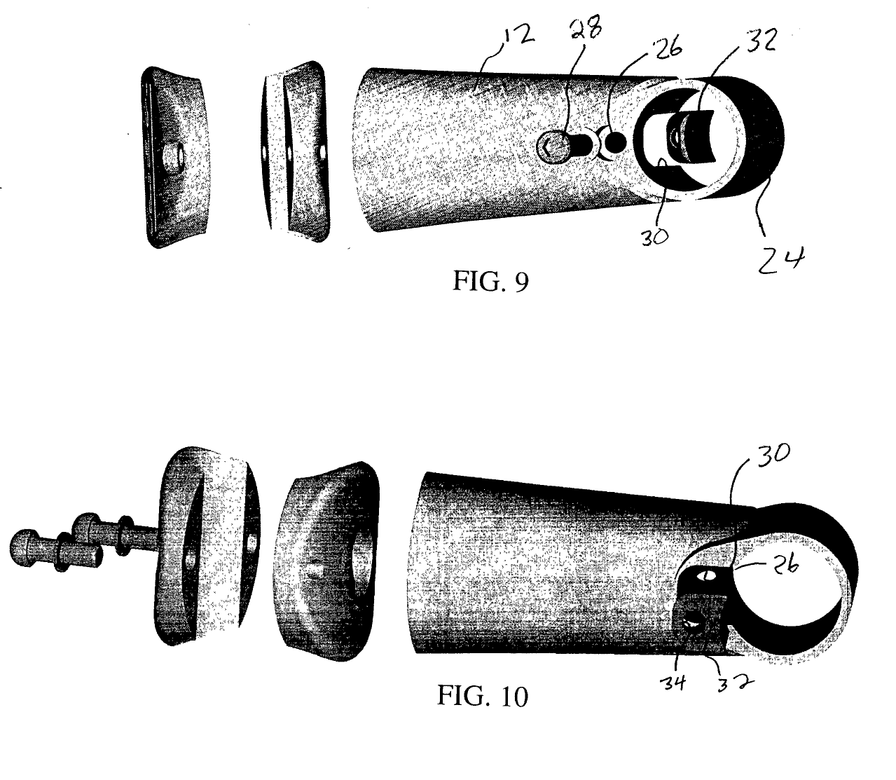

Referring now to FIG. 1, an exploded perspective view of the bicycle stem according to the present invention, the bicycle stem includes an elongate stem body 12, which is horizontally aligned in the drawing. The leftmost end of the stem body in the figure engages with a handle bar receiving clamp 14, which cooperates with handle bar clamp jaw portion 16 and threaded bolts 18, to clamp a handle bar tube (not shown). The bolts 18 fit through holes 20 in the clamp jaw portion 16 and are received in corresponding threaded holes 22 in the clamp 14. The inner faces of the clamp 14 and clamp jaw 16 have arcuate shapes so as to cooperate with the shape of a handle bar to allow clamping thereof when the bolts 18 are tightened.

At the end of stem body 12 opposite from the clamp 14, a vertically aligned tube portion 24 is defined. At the top of the body 12, near the tube portion, a vertical through bore 26 is defined for receiving threaded bolt 28. An arcuate tapered indentation 30 is formed in the inner face of the tube portion, from the bottom thereof (relative to the orientation of FIG. 1), extending upwardly part way up the vertical length of the tube. The indentation 30 is formed at the side of the tube where it meets the stem body 12. A wedge member 32, having a tapered profile that is a counterpart to the profile of the indentation 30 is removably receivable in the indentation, inside of the tube portion 24.

Referring to FIG. 6, which is a solid top exploded partial perspective view of the bicycle stem, looking down into the tube portion 24, it may be observed that wedge member 32 has a vertical bore 34 therein. Bore 34 is suitably threaded so as to threadingly engage the threads of bolt 28 when the stem is assembled. The inner face (that is, the face that is oriented towards the inside of the tube 24) of the wedge has an arcuate profile, but unlike the other face of the wedge, is not tapered.

When the stem is assembled, a fork tube 36 (shown in FIG. 3 in phantom, for illustrative purposes, representing the engagement point on the body of the bicycle) of a bicycle is received inside tube 24. Bolt 28 is positioned in hole 26, and wedge member 32 is brought up into the tapered indentation 30. The bolt is engaged with the threaded bore 34 in the wedge. The non-tapered arcuate face of the wedge engages the fork tube 36. Upon tightening of the bolt, the wedge is pulled into the indentation 30, and, as a result of the tapered profiles of the wedge and the indentation, the wedge is urged into tight engagement with the fork tube. Thereby, the bike stem is securely held to the fork tube of the bike. The handle bar 40 of the bike (shown in phantom in FIG. 3) is then clamped between clamp 14 and jaw portion 16, secured by cooperation of the bolts 18 and holes 20 and 22.

Bolts 18 may also operate to secure the clamp portion to the stem body 12, by engagement with threaded holes (not show) in the stem body. Alternatively, clamp portion 14 may be secured to the stem body by any suitable means, or may be defined as a unitary portion of the stem body.

The various drawing figures provide views of the bicycle stem from different angles, to assist in the understanding of the operation and structure thereof.

Accordingly an improved bicycle stem is provided, that enables easy secure clamping to the bicycle, while also enabling easy loosening and removal for adjustment, replacement, or repair.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A bicycle stem, comprising:
a stem body having a tapered indentation defined therein; and
a wedge member having a portion with a counterpart tapered shape to the tapered indentation.

2. The bicycle stem according to claim 1, wherein said wedge member has a bolt receiving portion and wherein said stem body carries a bolt, for engaging the bolt receiving portion of said wedge member.

3. The bicycle stem according to claim 1, wherein said wedge member has a bicycle part engaging profile on a face opposite the portion having the counterpart tapered shape.

4. The bicycle stem according to claim 3, wherein said part engaging profile comprises an arcuate profile.

5. The bicycle stem according to claim 4, wherein said arcuate profile comprises a circular profile.

6. A bicycle stem, comprising:
a stem body having a tubular member with a tapered indentation defined in an interior portion thereof, wherein an engaging member receiving bore is defined into the tapered indentation;
a wedge member having a portion with a counterpart tapered shape to the tapered indentation and an engaging member receiving portion therein, said wedge member having a profile on a portion thereof adapted to mate with a profile of a bicycle attachment part; and
an engagement member for passing through said receiving bore and meeting said engaging member receiving portion, for adjustably setting the position of said wedge member.

7. The bicycle stem according to claim 6, wherein said tubular member tapered indentation has a greater dimension on a longitudinal axis thereof, and where said longitudinal axis is oriented substantially vertically relative to a bicycle frame.

8. The bicycle stem according to claim 6, wherein said engagement member and said engagement member receiving portion of said wedge member threadably cooperate with one another.

9. The bicycle stem according to claim 6, wherein said engagement member comprises a threaded bolt and said engagement member receiving portion of said wedge member comprises a corresponding threaded bore.

10. A bicycle, comprising:
a frame having a stem engaging member;
a stem body for receiving said stem engaging member, and having a tapered indentation defined therein;
a wedge member having a portion with a counterpart tapered shape to the tapered indentation adjustably received in said tapered indentation; and
a securing member for securing said wedge relative to said stem body.

11. The bicycle according to claim 10, wherein said stem body receives said wedge member in a substantially vertical relation relative to said stem engaging member.

12. The bicycle according to claim 10, wherein said stem engaging member comprises a tubular portion.

13. The bicycle stem according to claim 10, wherein said tapered indentation has a greater dimension on a longitudinal axis thereof, and where said longitudinal axis is oriented substantially vertically relative to said bicycle frame.

14. The bicycle stem according to claim 10, wherein said securing member and said wedge member threadably cooperate with one another.

15. The bicycle stem according to claim 10, wherein said securing member comprises a threaded bolt and said wedge member carries a corresponding threaded bore therein.
